(19) United States
(12) Patent Application Publication
(10) Pub. No.: US 2024/0255031 A1
(43) Pub. Date: Aug. 1, 2024

(54) CONNECTING UNIT AND CONNECTING DEVICE FOR CONNECTING A DRIVE DEVICE TO A ROD, AND METHOD FOR EXCHANGING A DOCTOR ROD

(71) Applicant: Voith Patent GmbH, Heidenheim (DE)

(72) Inventors: Tobias Henle, Ulm (DE); Nico Appel, Lauingen (DE); Tony Sies, Heidenheim (DE); Uwe Joos, Konigsbronn (DE); Daniel Gronych, Heidenheim (DE); Christoph Henninger, Heidenheim (DE)

(73) Assignee: Voith Patent GmbH, Heidenheim (DE)

(21) Appl. No.: 18/629,340

(22) Filed: Apr. 8, 2024

Related U.S. Application Data
(63) Continuation of application No. PCT/EP2022/077081, filed on Sep. 29, 2022.

(30) Foreign Application Priority Data
Oct. 12, 2021 (DE) 10 2021 126 351.4

(51) Int. Cl. F16D 1/08

(52) U.S. Cl. CPC F16D 1/0805

(57) ABSTRACT

A connecting unit for connecting a drive device to a rod includes: a receiving opening for axially receiving a connecting element arranged on the rod to transmit a torque; an interlocking element including a free end and further including or being configured as a spring element, which is a flexible spring; and a recess located radially adjacent to the receiving opening and by way of which the interlocking element engages in the receiving opening, with the result that the connecting element is axially securable thereby, the interlocking element at a first position being firmly connected with a portion of the connecting unit and at the free end is configured for moving relative to a portion of the connecting unit so as to move the interlocking element out of the receiving opening, with the result that a securement of the connecting element is releasable.

### CROSS REFERENCE TO RELATED APPLICATIONS

This is a continuation of PCT application no. PCT/EP2022/077081, entitled “CONNECTING UNIT AND CONNECTING DEVICE FOR CONNECTING A DRIVE DEVICE TO A ROD, AND METHOD FOR EXCHANGING A DOCTOR ROD”, filed Sep. 29, 2022, which is incorporated herein by reference. PCT application no. PCT/EP2022/077081 claims priority to German patent application no. 10 2021 126 351.4, filed Oct. 12, 2021, which is incorporated herein by reference.

### BACKGROUND OF THE INVENTION

### 1. Field of the Invention

The present invention relates to treatment of material webs, and, more particularly, to connecting devices.

### 2. Description of the Related Art

For treatment of material webs in film presses, for example of paper or cardboard webs, a liquid or viscous coating medium is transferred with the help of applicator units in order to influence material characteristics such as penetration and surface coverage of the material. The amount of coating medium applied is thereby metered with the assistance of a doctor rod. The doctor rods are typically rotatably mounted in doctor rod holders and are connected at one or both ends to one or two drives via a coupling and are driven by said drive or drives.

To connect a doctor rod to a drive, various coupling arrangements are known, which detachably connect the doctor rod to the drive for torque transmission. If wear and tear occur on a doctor rod during operation, it may be necessary to replace it. Due to occasional contamination of the components by the coating medium, releasing and closing a coupling between the doctor rod and the drive can be expensive and time-consuming, which can lead to longer downtimes of the film press.

Based on this, what is needed in the art is an improved connecting unit which enables connecting or respectively releasing of a rod with or respectively from a drive or drive device. Moreover, what is also needed in the art is axial securing of the rod. In addition, what is also needed in the art is an improved connecting device and an improved method for replacing a rod or doctor rod.

### SUMMARY OF THE INVENTION

The invention relates to a connecting unit for connecting a drive device to a rod, in particular a doctor rod, wherein the connecting unit has a receiving opening which is designed to axially accommodate a connecting element arranged on a rod, in order to transmit a torque, and wherein the connecting unit has a recess which is radially adjacent to the receiving opening and by which a force-applied interlocking element of the connecting unit engages in the receiving opening, as a result of which the connecting element can be held in place axially. The invention moreover relates to a connecting device and a method for exchanging a rod, in particular a doctor rod.

A first aspect of the present invention provides a connecting unit for connecting a drive device with a rod, in particular a doctor rod, wherein the connecting unit has a receiving opening designed to axially accommodate a connecting element arranged on a rod in order to transmit a torque. The connecting unit has a recess radially adjacent to the receiving opening, through which a force-applied interlocking element of the connecting unit engages in the receiving opening, whereby the connecting element can be fixed axially. The interlocking element is firmly connected to the connecting unit at an initial position. At a free end, the interlocking element can be moved in relation to the connecting unit, in particular in relation to the receiving opening, in order to move the interlocking element out of the receiving opening, whereby the securement of the connecting element can be terminated. For example, the interlocking element can be moved tangentially. However, other forms of movement are also possible to release the securement of the connecting element.

The connecting unit permits securement against axial displacement of a connecting element which is arranged in the receiving opening and thus a rod arranged therein. In addition, operating of the connecting unit, in particular without tools, is made possible by the connecting unit in order to facilitate axial withdrawal or respectively insertion of a rod, for example for the purpose of replacement of a doctor rod from or into the receiving opening.

Such a connecting unit can usually be arranged or is arranged as a coupling device on a shaft or a drive shaft, which can be connected or is connected to a drive, in order to connect the drive to the doctor rod. For example, the connecting unit can be tubular, with a receiving opening being arranged for the connecting element of the rod on an open front side of the connecting unit. This receiving opening is arranged in particular axially relative to a rotational movement that is to be transmitted and is designed to form a connection with the connecting element, in particular an interlocking connection, in order to transmit a torque or a rotational force, in particular in a circumferential direction of the rod or the connecting element. For this purpose, a prismatic hollow geometry is typically known, for example an internal socket, an internal hexagon or an internal polygon with a suitable number of edges or surfaces, which can interact with a corresponding geometry of the connecting element of the rod in order to transmit the rotational movement. In the same way, the receiving opening can also be designed to form an interlocking and/or frictional connection with the connecting element, in particular to transmit a torque in a circumferential direction of the rod or the connecting element, or it can be designed to represent a combination of an interlocking and/or frictional and/or force-fit connection.

A recess is adjacent to the receiving opening and thus forms an opening or transition to the receiving opening through which the interlocking element can engage with the receiving opening. In particular, the recess is arranged at a distance from an end face of the connecting unit on the receiving opening side and can, for example, be designed as a radially positioned groove in the connecting unit. The recess can be designed to completely accommodate the interlocking element, and in particular to support it against axial deflection.

The force-applied interlocking element is designed to counter an opening movement of the interlocking element out of the receiving opening, in particular with the applied force, in order to keep the interlocking element in the receiving opening. The interlocking element can act as a barrier in the transverse direction to an axis of the rod and thus of the connecting element, thereby blocking an axial movement of the rod.

In particular, the interlocking element is set up or arranged in such a way that a transition between the recess and the receiving opening is at least partially covered or closed. The interlocking element may herein abut to the connecting unit, in particular in an area around the receiving opening or the transition in the recess, in particular force-reinforced, or may be arranged in such a way that there is an air gap between the interlocking element and the connecting unit. This can reduce sensitivity to contamination.

At a first position, the interlocking element is firmly connected to the connecting unit, in particular to form a support for the interlocking element or to secure the interlocking element to the connecting unit. Thus, the cited components of the connecting unit are firmly connected to each other, providing protection against loss of components during assembly or disassembly of a rod.

The interlocking element has a free end for releasing the securement of the connecting element in the connecting unit. The free end extends into the recess in such a way that it provides an easily accessible target point for actuation. When actuating the interlocking element, it is moved in a circumferential direction relative to the connecting unit, in particular at the free end, in particular against the direction of its applied force, in order to move the interlocking element out of the receiving opening and to release the axial securement of the connecting element. This movement of the free end of the interlocking element can occur as a pivoting movement, especially around a support point created by the first position, which allows for easy handling.

In one embodiment of the connecting unit, the receiving opening is designed as an internal polygon, wherein the recess intersects at least two surfaces of the internal polygon. For example, the receiving opening can be designed as an internal square, internal hexagon or internal octagonal, wherein the recess intersects two adjacent surfaces of the geometry. In this way, a recess is provided that provides for engagement of the interlocking element into the receiving opening, thereby providing securement of a connecting element. Adjacent surfaces, which may also be curved, can for example also be connected by rounded transitions, so that, for example, geometries such as spline shaft profiles, Torx- or polygon profiles are also understood as internal polygons for the transmission of torques. The transition between the recess and the receiving opening can thus have an expansion, especially a reduced one, which can prevent contamination or clogging of the components by a coating medium.

In one embodiment of the connecting unit, the interlocking element includes a spring element or is designed as a spring element. The spring element can herein be a flexible spring and can be designed, for example, as a leaf spring, flat spring or flat form spring. In particular, the spring element is used to absorb lateral forces acting in the axial direction between the connecting unit and the connecting element. A spring force of such an interlocking element can represent a safeguard against unintentional detachment of the interlocking element from the receiving opening and can in addition provide for simple construction of the connecting unit.

In particular, in order to release a securement provided by the spring element, the spring element can be moved or lifted at the free end manually and directly without the use of a tool, as a result of which the spring element moves out of the receiving opening and can thus release a connecting element which is located in the receiving opening. The spring element can thereby be moved out of the receiving opening, around a support provided or created at the first position, in particular in an arched manner, in a radial direction against a spring force of the spring element.

The interlocking element may have an engaging element at its free end, in particular facing away from the first position. The engaging element can be formed by a bend or fold, in particular a seamless fold. This makes it possible to actuate for example the spring element, especially without tools, as the interlocking element can be grasped and moved more easily by a user.

In one embodiment, the interlocking element is designed as a leaf spring, in particular a flat leaf spring, and can be arranged in the recess so as to be aligned tangentially to the receiving opening and/or designed to be at least partially accommodated by the receiving opening in order to at least partially close or cover it radially. The interlocking element can herein be arranged in a plane of the recess that is positioned in particular tangential to the receiving opening, or respectively tangential to the receiving opening, and be connected there to the connecting unit. For example, an interlocking connection in the form of a screw connection can be provided. With this embodiment, a simple assembly of the connecting unit can be made possible.

In one embodiment, the spring element is designed as a curved or angled flat spring. In particular, the interlocking element can have, form or span an angle of 90°. The first position can hereby be arranged offset perpendicular to a free end of the interlocking element: For example, the connection of the interlocking element with the connecting unit can be arranged perpendicular to or offset by 90° to a plane in which the interlocking element engages in the receiving opening. With this embodiment for example, the length of the interlocking element and thus a lever of the interlocking element can be extended, facilitating actuation and lifting of the interlocking element.

In one embodiment, the interlocking element can be designed as a flat spring, in particular an angled flat spring, which is pretensioned, in particular with respect to the receiving opening. As a result-in a locking position in which the interlocking element is arranged in the receiving opening-a force can act on the connecting unit to hold the interlocking element in position. Inadvertent opening of the interlocking element can thus be avoided or prevented.

In one embodiment the interlocking element has a supporting body. Here, the supporting body can face the receiving opening or be allocated to same and can be designed to engage at least partially into it. For example, a cuboid support body can be arranged on a flat side of an interlocking element designed as a flat spring facing the receiving opening, in particular fixed or screwed to it. The support body can increase the cross-section of the interlocking element, which can absorb shear loads, particularly in the case of forces acting axially on the connecting element or between the connecting unit and the connecting element. This can increase the maximum transverse load that can be absorbed and can, for example, prevent or avoid deflection of the interlocking element when a force is applied.

In one embodiment, the interlocking element is arranged in a locking position within a circumference of the connecting unit, in particular in such a way that none of the components protrude beyond the outer circumference of the connecting unit. In a locking position, the interlocking element engages with the receiving opening. The interlocking element can, for example, be arranged in the recess, or the securement recess formed on the connecting element can be designed in such a way that the interlocking element is completely accommodated in the recess of the connecting unit when it engages in the securement recess of the connecting element arranged in the receiving opening. In particular, the longitudinal extension of the interlocking element is less than a diameter of the connecting unit. This can, in particular, increase operational reliability and reduce susceptibility to wear and tear. The recess can, for example be designed as a groove which is arranged radially in the connecting element and which, in particular, partially protrudes beyond the receiving opening in the circumferential direction and intersects the latter at one point in such a way that the interlocking element can engage in the receiving opening.

The circumference of the connecting unit may for example, be round or include a way of engagement for a tool, in particular to effect a rotational movement about a longitudinal axis of the connecting unit or a rod accommodated therein. This way of engagement may for example, have an external square or an external hexagon or be designed as such and be located at a distance from or adjacent to a face side of the connecting unit on the receiving opening side. This facilitates, for example, rotation of the doctor rod for assembly or disassembly.

The connecting element can have a connecting element for a protective device, for example a bellows. In addition, the connecting element can have a coupling device, in particular at its end facing away from the receiving opening, which is designed to be connected to the drive device or a component of the drive device. Thus, the connecting element can be used flexibly also for example on existing drive devices.

In one embodiment, the free end of the interlocking element can be moved from one circumferential side of the connection unit without tools. For this purpose, the recess can have an actuation area in an area in which the free end of the interlocking element is arranged to enable the interlocking element to be actuated, in particular manually. It may additionally be provided that an engagement area is formed in or on the recess in order to allow access to the interlocking element with an operator's finger. For example, in the area of the recess, a chamfer of the connecting element may be provided, into which a free end, in particular the free end of the interlocking element can protrude. As a result, the operability of the interlocking element and thus of the connecting unit can be improved.

A second aspect of the present invention provides a connecting device for connecting a drive device to a rod, in particular a doctor rod. The connecting device includes a herein described connecting unit and a connecting element arranged on a rod. The connecting element can be arranged to interlock in the receiving opening of the connecting unit and has a radially arranged securement recess, which is designed to accommodate an interlocking element arranged on the connecting unit in order to lock the rod into position axially.

The connecting device can be used to transmit a torque and secure the rod against axial displacement. In addition, operation of the connecting device is made easier, in particular in regard to release of the safety device.

The connecting unit of this connecting device includes herein features and characteristics of at least one of the previously described embodiments of the connecting unit. Moreover, the connecting element of the connecting device includes at least one feature and/or a characteristic of a connecting element already previously described in connection with the connecting unit.

A rod of such a connecting device, for example a doctor rod, has a connecting element on at least one of its ends which is designed to be arranged in an interlocking manner in the receiving opening or to be inserted axially into the latter. This interlocking connection between connecting element and receiving opening facilitates the transfer of a rotational motion in circumferential direction. In some design variations the doctor rod may have a connecting element on both of its ends in order to be connected respectively with one connecting unit.

In particular, the securement recess is arranged and/or designed on the connecting element in such a way that it is aligned with the recess of the connecting unit when the connecting element is arranged in the receiving opening, wherein engagement of the interlocking element in the securement recess can be enabled.

In one embodiment, the securement recess of the connecting element is arranged circumferentially. In particular, the securement recess is designed as a circumferential recess or groove or an offset, which is designed to accommodate the interlocking element, at least partially. This simplifies the assembly of the rod, as the angular orientation of the securement recess in relation to the connecting element can be ignored. A cross-sectional profile of the recess can be designed at right angles, which can reduce the risk of the connecting element slipping out due to axial forces.

In one embodiment, one end face of the connecting element can have a chamfer, particularly around the edge. Such a chamfer allows the interlocking element to glide along the chamfer when the connecting element is inserted in order to facilitate placement of the connecting element in the receiving opening.

In an additional aspect, the present invention provides a method for the replacement of a rod, in particular a doctor rod, by way of a connecting device which includes a connecting unit with a receiving opening in which a connecting element which is arranged on the rod can be arranged in an interlocking manner in order to transmit a torque. The connecting unit has a recess radially adjacent to the receiving opening by which a force-applied interlocking connecting element of the connecting unit engages in the receiving opening and in a radially arranged securement recess of the connecting element, in order to secure the rod axially. The interlocking element is thereby firmly connected in a first position to the connecting unit. To release a securement of the connecting element, the interlocking element is moved at a free end relative to the connecting unit in a release step, for example tangentially, in order to move the interlocking element out of the receiving opening.

The method facilitates easy, in particular manual, detachment without the use of tools, in particular of an interlocking securement of the rod in the connecting unit.

The connecting device used with the method for replacement of a rod has the features and characteristics of at least one of the previously described embodiments of the connecting device and in particular the connecting unit and the connecting element.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a first exemplary design example of a connecting device for connecting a drive device to a rod;

FIG. 2 is a schematic representation of a second exemplary design example of a connecting device for connecting a drive device with a rod;

FIGS. 3A, 3B, and 3C are schematic representations of exemplary connecting units for connecting a drive device with a rod; and

FIG. 4 is a schematic representation of a sequence of the method according to the present invention for replacement of a rod.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

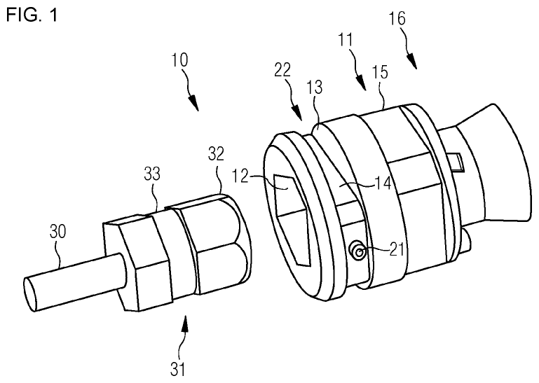

FIG. 1 shows a schematic representation of an exemplary connecting device 10 For connecting a drive device with a rod 30-in this instance a doctor rod 30.

Connecting device 10 includes a connecting unit 11 with a receiving opening 12 which, in this example is designed as an internal hexagon. Receiving opening 12 is designed to axially accommodate a connecting element 31 arranged on a rod 30 in order to transmit a torque.

Connecting unit 11 has a circumferential way of engagement 15 to enable an interlocking connection with a tool and thus a rotation of connecting device 10 with doctor rod 30. In this design example, way of engagement 15 is designed as an external square and is arranged at a distance from the end face of connecting unit 11 which incorporates receiving opening 12. At an end opposite this end face, connecting unit 11 includes a coupling device 16, which is designed to be connected to a drive device (not shown).

Connecting unit 11 has a recess 13 radially adjacent to receiving opening 12, through which a force-applied interlocking element 14 of connecting unit 11 can engage in receiving opening 12, whereby connecting element 31 can be axially secured. In first position 21, interlocking element 14 is firmly connected with connecting unit 11. In the illustrated design example, interlocking element 14 is designed as an angled flat spring, which encompasses an angle of 90°, which can be moved tangentially at free end 22 relative to connecting unit 11. Thus, interlocking element 14 can be moved out of receiving opening 12 whereby the securement of connecting element 31 can be released.

In the illustrated design example, connecting element 31 is designed as an external hexagon in order to be accommodated in receiving opening 12 in an interconnecting manner and thus enable transmission of a rotary movement about longitudinal axis of rod 30. At its end face, connecting element 31 has a chamfer 32, which can facilitate insertion of connecting element 31 into receiving opening 12.

Connecting element 31 has a radially positioned securement recess 33 which—in the illustrated design example—is designed as a circumferential groove with a rectangular cross section in order to block an axial movement relative to interlocking element 14 arranged therein in an interlocking position. Securement recess 33 is located at a distance from the free face end of connecting element 31, in order to achieve axial securement in both axial directions. In one locking position in which connecting element 31 is accommodated by receiving opening 12, securement recess 33 is aligned with recess 13 in order to facilitate engagement of interlocking element 14 and thus axial securement or securement between connecting unit 11 and connecting element 31.

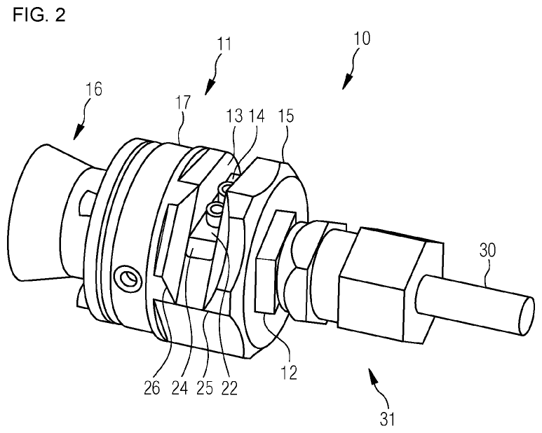

FIG. 2 shows a second exemplary design example of a connecting device 10. Connecting device 10 includes a connecting unit 11 and a doctor rod 30 with a connecting element 31, which are shown here in an unassembled state, in other words, not connected or engaged with each other.

In this design example, connecting unit 11 has a force-applied interlocking element 14 arranged in a securement recess 13, which is designed as a flat spring element. On a flat side of spring element 14 opposite receiving opening 12, securement ways are shown in the form of screws, by way of which a support body 18, which is not visible in FIG. 2, is attached to spring element 14. At its end, which is turned away from first position 21, interlocking element 14 has a free end 22 in order to allow interlocking element 14 to be moved.

In the illustrated design example, interlocking element 14 has an element of engagement 24 at free end 22 in order to enable spring element 14 to be actuated, in particular to be lifted manually, for example with one finger by operator. Interlocking element 14 is accommodated in recess 13, which has an operating range 25 in a region associated with the free end of interlocking element 14, as a result of which the free end of interlocking element 14 is arranged freely or operably within circumference of connecting unit 11. In the region of the free end of interlocking element 14, recess 13 can have an engagement region 26, which extends operating region 25 in order to enable interlocking element 14 to be gripped, for example with a finger.

Engagement ways 15 are provided on the circumference of connecting unit 11, in particular for rotating of connecting unit 11 about a longitudinal axis, which adjoins a free end face of connecting unit 11 and is arranged in the axial direction on both sides of recess 13. In addition, connecting unit 11 in this design example features a connecting device 17 for a protective device.

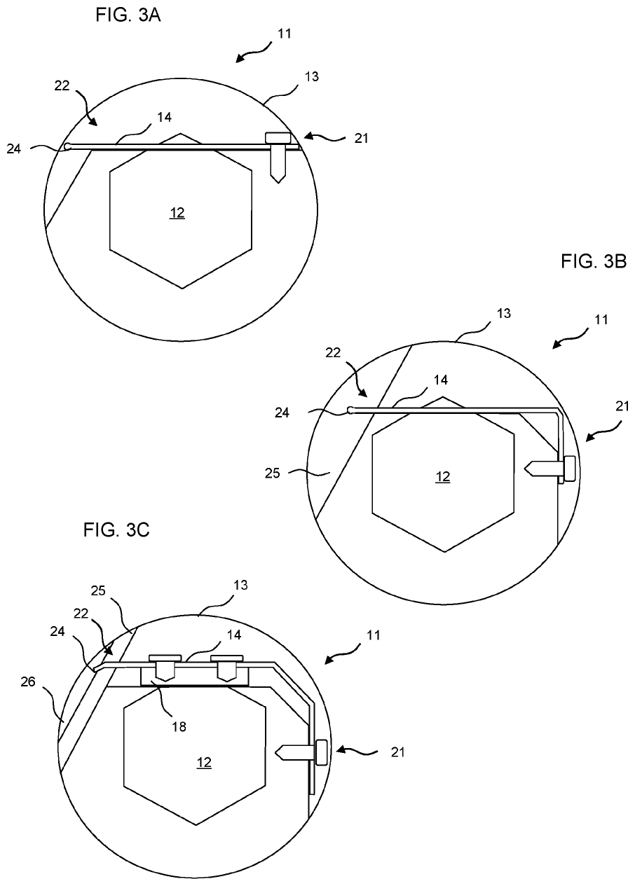

FIGS. 3A to 3C show a cross-sectional view of a design example of a connecting unit 11 in a plane perpendicular to an axis of rotation of connecting device 10 or in a plane of motion of an interlocking element 14. Connecting unit 11 always has a receiving opening in the shape of an internal hexagon 12, to which a recess 13 adjoins in radial direction in order to form a transition or respectively an opening with same.

In the embodiment shown in FIG. 3A, interlocking element 14 is designed as a straight leaf spring and engages in receiving opening 12 in the illustrated interlocking position in order to axially secure a connecting element 31 (not shown) of a doctor rod 30 arranged therein. At a first position 21, interlocking element 14 is firmly connected to connecting unit 11 by way of a screw in order to form a support for interlocking element 14.

Recess 13 has an operating range 25 in a region of a free end 22 of interlocking element 14 in order to allow free end 22 to be actuated or respectively moved. Interlocking element 14 has an engagement element 24 to facilitate manual gripping or actuation of interlocking element 14.

FIG. 3B illustrates an additional embodiment of a connecting element 11, whereby a receiving opening 12 therein adjoins a recess 13 of connecting unit 11 in order to accommodate an interlocking element 14, at least partially. Interlocking element 14 is designed as a flat spring and spans an angle of 90° between first position 21 and a free end 22. This makes it possible to extend the length of interlocking element 14 and thus to provide an improved lever for actuating interlocking element 14.

In the area of a free end of interlocking element 14, recess 13 has an operating range 25 to enable interlocking element 14 to be moved. In addition, engagement area 26 is arranged on recess 13 to enable an engagement element 24 of interlocking element 14 to be gripped with a finger.

FIG. 3C shows an additional design example of a connecting unit 11, which is extensively consistent with the design examples of FIGS. 3A and 3B.

In the embodiment shown in FIG. 3C, interlocking element 14 is designed as an angled flat spring, which encompasses an angle of 90° and is pretensioned in relation to receiving opening 12 in order to prevent accidental detachment of interlocking element 14 from receiving opening 12. A support body 18 is arranged on a flat side of interlocking element 14 assigned to receiving opening 12, which engages at least partially with receiving opening 12 in a locking position. By way of the support body, a cross-section of interlocking element 14 can be enlarged to further improve the absorption of lateral forces.

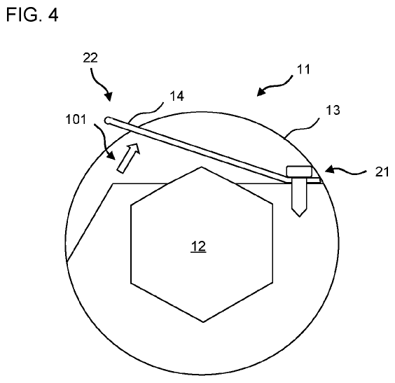

FIG. 4 shows a schematic representation of a sequence of one design example of the method for replacement of a rod 30. FIG. 4 shows a connecting unit 11 according to the design example of FIG. 3A, whereby in a step 101 (direction of movement represented by an arrow) interlocking element 14 is moved at a second end 22 relative to connecting unit 11 in order to move interlocking element 14 out of receiving opening 12 and to release securement of connecting element 31 of rod 30. Interlocking element 14 is hereby moved about a first position 21, which represents a support for interlocking element 14, and is thus released from receiving opening 12 and a securement recess 33 in order to release connecting element 3.

### COMPONENT REFERENCE LISTING

10 connecting device
11 connecting unit
12 receiving opening
13 recess
14 force-applied interlocking element
15 way of engagement
16 coupling device
17 connecting device
18 support body
21 first position
22 free end
24 engagement element
25 operating region
26 area of engagement
30 rod, doctor rod
31 connecting element
32 chamfer
33 securement recess
101 release step

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A connecting unit for connecting a drive device to a rod, the connecting unit comprising:
a receiving opening configured for axially receiving a connecting element arranged on the rod so as to transmit a torque;
an interlocking element, which is a force-applied interlocking element, the interlocking element including a free end, the interlocking element further including or being configured as a spring element, the spring element being a flexible spring; and
a recess located radially adjacent to the receiving opening and by way of which the interlocking element engages in the receiving opening, with the result that the connecting unit is configured such that the connecting element is axially securable thereby, the interlocking element at a first position being firmly connected with a portion of the connecting unit and at the free end is configured for moving relative to a portion of the connecting unit so as to move the interlocking element out of the receiving opening, with the result that the connecting unit is configured such that a securement of the connecting element is releasable.

2. The connecting unit according to claim 1, wherein the receiving opening is configured as an internal polygon which includes at least two surfaces, and wherein the recess intersects the at least two surfaces of the internal polygon.

3. The connecting unit according to claim 1, wherein the spring element is configured for absorbing a plurality of lateral forces acting in an axial direction between the connecting unit and the connecting element.

4. The connecting unit according to claim 1, wherein the interlocking element includes a support body.

5. The connecting unit according to claim 1, wherein the connecting unit includes a circumference, wherein the interlocking element is arranged in a locking position within the circumference of the connecting unit.

6. The connecting unit according to claim 1, wherein the connection unit includes a circumferential side, wherein the free end of the interlocking element is configured for being moved from the circumferential side of the connection unit.

7. The connecting unit according to claim 1, wherein the connection unit includes a circumferential side, wherein the free end of the interlocking element is configured for being moved from the circumferential side of the connection unit without using a tool.

8. The connecting unit according to claim 1, wherein the spring element is a leaf spring, a flat spring, or a flat form spring.

9. The connecting unit according to claim 1, wherein the connecting unit is configured for connecting the drive device to the rod, which is a doctor rod.

10. A connecting device to connect a drive device with a rod, the connecting device comprising:
a connecting unit for connecting the drive device to the rod, the connecting unit including:
a receiving opening configured for axially receiving a connecting element arranged on the rod so as to transmit a torque;
an interlocking element, which is a force-applied interlocking element, the interlocking element including a free end, the interlocking element further including or being configured as a spring element, the spring element being a flexible spring; and
a recess located radially adjacent to the receiving opening and by way of which the interlocking element engages in the receiving opening, with the result that the connecting unit is configured such that the connecting element is axially securable thereby, the interlocking element at a first position being firmly connected with a portion of the connecting unit and at the free end is configured for moving relative to a portion of the connecting unit so as to move the interlocking element out of the receiving opening, with the result that the connecting unit is configured such that a securement of the connecting element is releasable; and
a connecting element configured for being arranged on the rod and for being arranged in an interlocking manner in the receiving opening of the connecting unit, the connecting element including a securement recess which is radially arranged and which is configured for accommodating the interlocking element arranged on a portion of the connecting unit so as to secure the rod into position axially.

11. The connecting device according to claim 10, wherein the securement recess of the connecting element is arranged circumferentially.

12. The connecting device according to claim 10, wherein the connecting element includes and end face and a chamfer at the end face.

13. The connecting device according to claim 10, wherein the connecting device is configured for connecting the drive device to the rod, which is a doctor rod.

14. A method to replace a rod, the method comprising the steps of:
providing that the connecting device includes a connecting unit and a connecting element, the connecting unit including a receiving opening in which the connecting element—which is arranged on the rod—is arranged in an interlocking manner so as to transmit a torque, the connecting unit including a recess located radially adjacent to the receiving opening and by which an interlocking element—which is a force-applied interlocking element—of the connecting unit engages in the receiving opening and in a securement recess—which is radially arranged—of the connecting element so as to secure the rod axially, the interlocking element being firmly connected in a first position with a portion of the connecting unit, the interlocking element including or being configured as a spring element, the spring element being a flexible spring,
moving the interlocking element at a free end of the interlocking element relative to the connecting unit in a release step so as to move the interlocking element out of the receiving opening and to release a securement of the connecting element; and
replacing the rod by way of the connecting device.

15. The method according to claim 14, wherein the spring element is a leaf spring, a flat spring, or a flat form spring.

16. The method according to claim 14, wherein the rod is a doctor rod.
